(19) United States
(12) Patent Application Publication
(10) Pub. No.: US 2013/0135349 A1
(43) Pub. Date: May 30, 2013

(54) Virtual Trial and Fitting Room

(71) Applicants: Srikanth Narayanan, San Diego, CA (US); Sriram N, Bangalore (IN)

(72) Inventors: Srikanth Narayanan, San Diego, CA (US); Sriram N, Bangalore (IN)

(21) Appl. No.: 13/648,886

(22) Filed: Dec. 22, 2012

Related U.S. Application Data
(60) Provisional application No. 61/545,716, filed on Oct. 11, 2011.

(51) Int. Cl. G06T 11/00

(52) U.S. Cl. CPC G06T 11/00
USPC 345/634

(57) ABSTRACT

This invention is a system and method that allows wearing or trying on clothes virtually by a user of any body shape or size. A Web server on the World Wide Web provides pictures of apparel such as dress, gowns, tops, blouse, skirts, pants. A user provides his/her picture and is able to virtually try on the apparel article of choice.

### CROSS-REFERENCE TO RELATED APPLICATIONS

Priority is claimed from Non-Provisional U.S. Patent Application Ser. No. 61/545,716, “Virtual Trial And Fitting Room” filed on Oct. 11, 2011

### STATEMENT REGARDING FEDERALLY SPONSORED RESEARCH OR DEVELOPMENT

Not Applicable

### FIELD OF THE INVENTION

This invention is in the field of e-commerce and fashion.

### BACKGROUND OF THE INVENTION

Proliferation of internet accessible devices such as smartphones, tablets, laptops, PCs and high speed broadband demand greater personal involvement of a user when shopping for apparel such as tops, bottoms, shirts, blouses, pants, skirts and the like, be it on-line using the World Wide Web or in a brick'n mortar store. Apparel merchandise presented through the internet medium is shortcoming, in that the user of any body shape or size not able to visualize how it would look on them or how others would perceive. More often this results in returns causing losses to the retailer and dissatisfaction to the user. Therefore there is a compelling need to be able to try on the apparel articles such as tops, bottoms, shirts, blouses, pants, skirts and evaluate the look.

### SUMMARY OF THE INVENTION

An object of this invention is to improve the quality of shopping experience by providing pictures of apparel such as dress, tops, blouse, shirt, pants, trousers, skirts, gowns, bridal gowns that can be superimposed on a picture of the user. A user uploads his/her picture and chooses a web page presenting apparel such as dress, skirts, tops, blouses etc and clicks on the picture of the apparel. This chosen image is overlaid on the user's picture to present an impression of the user wearing that apparel. This invention renders a photo realistic image of the apparel (dress, tops, shirt, blouse, skirt) on the user.

### BRIEF DESCRIPTION OF THE DRAWINGS

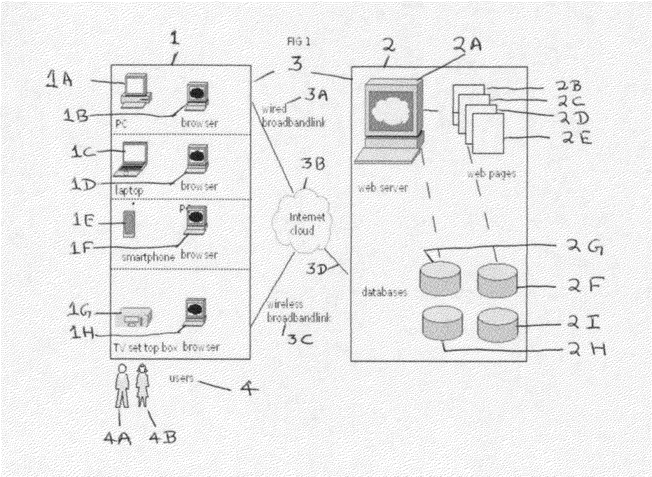

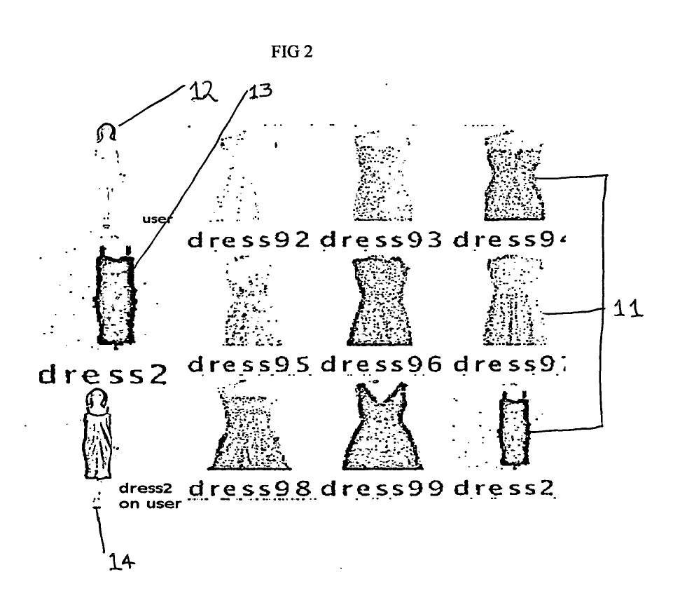

FIG. 1 details Web server that is accessible by the user using a PC, laptop, smartphone or TV Set top box. Web server maintains databases of the apparel pictures and presents them to the user via web pages.
1: Includes the Sub-sections 1A, 1B, 1C, 1D, 1E, 1F, 1G and 1H. These are the various devices like PC, Laptop, Smartphone, TV Set top box to access the web server depicted in 2A.
2: Includes the sub-sections of 2A, 2B, 2C 2D, 2E, 2F, 2G, 2H and 2I. Web server provides apparel pictures from database through a web page
3: Communication media. These include sub-sections 3A, 3B, 3C and 3D. These are the communication channels that the various devices may utilize to access the Web server.
4: Includes sub-sections 4A and 4B. These are the users who access the various devices of PC, Laptop, Smartphone or TV Set top box.
1A: PC device using web browser, 1B to access 2A
1B: Web browser application in PC
1C: Laptop device using web browser, 1D to access 2A
1D: Web browser application in Laptop
1E: Smartphone device using web browser, 1F to access 2A
1F: Web browser application in Smartphone
1G: TV Set top Box device using web browser, 1H to access 2A
1H: Web browser application in TV set top box
4A: Male user
4B: Female user
2A: Web server that retrieves the clothing images from databases 2G, 2F, 2I and 2H and presents them for access by the various devices of PC, Laptop, Smartphone or TV Set top box by rendering them in web pages 2B, 2C, 2D or 2E.
2B: Web page depicts FIG. 2 sub-section 11. This is the sample clothing images of a certain fashion or style. Depicted here are dresses. Depictions may be tops, blouses, shirts, skirts, bottoms, pants, gowns, costumes.
2C: Web page depicts FIG. 2, sub-section 12. Depicted here is the picture of a user.
2D: Web page depicts FIG. 2, sub-section 13. Depicted here is a picture of the clothing image that the user has chosen, dress 2.
2E: Web page depicts FIG. 2, sub-section 14. Depicted here is the picture of user wearing the dress 2.
2F: Database—stores user information and pictures
2G: Database—stores articles for a specific retailer, manufacturer, fashion consultant, image consultant, magazine publication
2H: Database—stores modified images of a user that may or may not be made publicly available
2I: Database—stores logs and statistics of users, user access, usage, image access.
3A: Depicts wired broadband link such as DSL, Cable modem, T1, ISDN, Ethernet
3B: Depicts the Internet cloud to include all physical connectivity
3C: Depicts wireless broadband link such as Wi-FI, WiMax, Satellite, Mobile broadband
3D: Depicts wired broadband link of Web Server to Internet cloud

FIG. 2 has the following sub- sections—
11—List of apparel: dress 92, dress 93, dress 94, dress 95, dress 96, dress 97, dress 98, dress 99 and dress 2.
12—Picture of user.
13—Picture of selected dress, dress 2
14—Picture showing user wearing dress 2.

### DETAILED DESCRIPTION OF THE INVENTION

A user uploads her picture and chooses a web page presenting apparel such as dress, skirts, tops, blouses etc and clicks on the picture of the apparel. This chosen image is overlaid on the user's picture to present an impression of the user wearing that apparel. This invention renders a photo realistic image of the apparel (dress, tops, shirt, blouse, skirt) on the user.

A user represented by FIG. 1 Sub-section 4B, accesses the Web Server, FIG. 1 Sub-section 2A and browses through a Web page represented by FIG. 1 Sub-section 2B. Web page 2B contains the information of apparel represented by FIG. 2 Sub-section 11, containing a plurality of apparel images of dress 92, dress 93, dress 94, dress 95, dress 96, dress 97, dress 98 and dress 2.

The user selects dress 2, and this is depicted in Web page FIG. 1 Sub-section 2D and this Web page contains the information represented by FIG. 2 Sub-section 13. A Web page, FIG. 1 Sub-section 2C prompts the user to upload her full body picture and upon uploading, this image is depicted in FIG. 2 Sub-section 12.

The user selects dress 2 in FIG. 2 Sub-section 13 on Web page FIG. 1 Sub-section 2C. A resultant image, FIG. 2 Sub-section 14 , duly processed by computer graphics algorithms and techniques is generated and displayed on Web page FIG. 1 Sub-section 2E. All user, apparel images, resultant images, user statistics and logs are stored in databases represented by Sub-sections 2G, 2F, 21 and 2H of FIG. 1.

In one embodiment, the Web server may be a web server extension of a specific retailer, fashion consultant, image consultant, or manufacturer and their users with databases containing pictures of apparel specific to their choice.

In another embodiment, the Web pages may itemize apparel choices of a specific manufacturer, retailer, popularity, fashion season, special occasion wear, age, demographic, gender demographic and style.

While this invention's description enables one of ordinary skill to make and use the systems and methods, there are equivalents and alternates of the examples provided and therefore without being limited to the presented embodiments, these equivalents and alternates should be considered to be within the spirit and scope of this invention.

1. A method of super imposing an image of an apparel item such as a dress on any body shape or size belonging to user or a mannequin in order to assess the look, fit, social media opinion or to purchase.
